(19) United States
(12) Patent Application Publication
(10) Pub. No.: US 2021/0081788 A1
(43) Pub. Date: Mar. 18, 2021

(54) METHOD AND APPARATUS FOR GENERATING SAMPLE DATA, AND NON-TRANSITORY COMPUTER-READABLE RECORDING MEDIUM

(71) Applicants: Lei DING, Beijing (CN); Yixuan TONG, Beijing (CN); Jiashi ZHANG, Beijing (CN); Shanshan JIANG, Beijing (CN); Yongwei ZHANG, Beijing (CN)

(72) Inventors: Lei DING, Beijing (CN); Yixuan TONG, Beijing (CN); Jiashi ZHANG, Beijing (CN); Shanshan JIANG, Beijing (CN); Yongwei ZHANG, Beijing (CN)

(73) Assignee: Ricoh Company, Ltd., Tokyo (JP)

(21) Appl. No.: 17/015,560

(22) Filed: Sep. 9, 2020

(30) Foreign Application Priority Data
Sep. 17, 2019 (CN) 201910875573.1

(51) Int. Cl. G06N 3/08; G06N 7/00

(52) U.S. Cl. CPC G06N 3/08; G06N 7/005

(57) ABSTRACT

A method and an apparatus for generating sample data, and a non-transitory computer-readable recording medium are provided. In the method, at least two weak supervision recommendation models of a recommendation system are generated; a dependency relation between the at least two weak supervision recommendation models is learned by training a neural network model; and the sample data is re-labelled using the trained neural network model to obtain updated sample data.

### CROSS-REFERENCE TO RELATED APPLICATIONS

The present application claims priority under 35 U.S.C. § 119 to Chinese Application No. 201910875573.1 filed on Sep. 17, 2019, the entire contents of which are incorporated herein by reference.

### BACKGROUND OF THE INVENTION

### 1. Field of the Invention

The present disclosure relates to the field of machine learning, and specifically, a method and an apparatus for generating sample data, and a non-transitory computer-readable recording medium.

### 2. Description of the Related Art

Recently, recommendation systems (recommender systems) have been successfully applied in various fields such as search engines, e-commerce websites and the like. The recommendation system constructs a recommendation model based on mined user data, and recommends products, information and services that meet the needs of a user to the user, thereby helping the user solve the problem of information overload.

In conventional recommendation systems, a training process of a recommendation model is regarded as supervised learning, and labels (such as ratings) may be generated from specific behaviors of users. This explicit method provides clear labels, however the authenticity of these labels may be problematic because false labeling may be made by users for various reasons.

Supervised learning technology constructs a recommendation model by learning a large number of training samples, where each training sample has a label indicating its true output. Although the conventional technology has achieved great success, it is difficult to obtain strong supervision information such as all labels being true for many tasks due to the high cost of the data labeling process. Thus, it is desirable to use weak supervised machine learning.

Weak supervised learning means that labels of training samples are unreliable, and for example, in a case of (x, y), the label of y for x is unreliable. Unreliable labels here include incorrect labels, multiple labels, insufficient labels, partial labels or the like. The learning with incomplete supervision information or unclear objects are collectively referred to as weak supervised learning. The performance of a recommendation model constructed based on weak supervised learning may be adversely affected, because label reliability of training samples is poor.

### SUMMARY OF THE INVENTION

According to an aspect of the present disclosure, a method for generating sample data is provided. The method includes generating at least two weak supervision recommendation models of a recommendation system; learning a dependency relation between the at least two weak supervision recommendation models by training a neural network model; and re-labelling, using the trained neural network model, the sample data to obtain updated sample data.

According to another aspect of the present disclosure, an apparatus for generating sample data is provided. The apparatus includes a recommendation model obtaining unit configured to generate at least two weak supervision recommendation models of a recommendation system; a neural network model learning unit configured to learn a dependency relation between the at least two weak supervision recommendation models by training a neural network model; and a re-labelling unit configured to re-label, using the trained neural network model, the sample data to obtain updated sample data.

According to another aspect of the present disclosure, an apparatus for generating sample data is provided. The apparatus includes a memory storing computer-executable instructions; and one or more processors. The one or more processors are configured to execute the computer-executable instructions such that the one or more processors are configured to generate at least two weak supervision recommendation models of a recommendation system; learn a dependency relation between the at least two weak supervision recommendation models by training a neural network model; and re-label, using the trained neural network model, the sample data to obtain updated sample data.

According to another aspect of the present disclosure, a non-transitory computer-readable recording medium having computer-executable instructions for execution by one or more processors is provided. The computer-executable instructions, when executed, cause the one or more processors to carry out a method for generating sample data. The method includes generating at least two weak supervision recommendation models of a recommendation system; learning a dependency relation between the at least two weak supervision recommendation models by training a neural network model; and re-labelling, using the trained neural network model, the sample data to obtain updated sample data.

### BRIEF DESCRIPTION OF THE DRAWINGS

The above and other objects, features and advantages of the present disclosure will be further clarified by describing, in detail, embodiments of the present disclosure in combination with the drawings.

FIG. 1 is a flowchart illustrating a sample data generating method according to an embodiment of the present disclosure.

FIG. 2 is a schematic diagram illustrating a constructed neural network model according to the embodiment of the present disclosure.

FIG. 3 is a flowchart illustrating a sample data generating method according to another embodiment of the present disclosure.

FIG. 4 is a schematic diagram illustrating a sample data generating apparatus according to an embodiment of the present disclosure.

FIG. 5 is a schematic diagram illustrating a sample data generating apparatus according to another embodiment of the present disclosure.

FIG. 6 is a block diagram illustrating the configuration of a sample data generating apparatus according to another embodiment of the present disclosure.

### DESCRIPTION OF THE EMBODIMENTS

In the following, specific embodiments of the present disclosure will be described in detail with reference to the accompanying drawings, so as to facilitate the understanding of technical problems to be solved by the present disclosure, technical solutions of the present disclosure, and advantages of the present disclosure. The present disclosure is not limited to the specifically described embodiments, and various modifications, combinations and replacements may be made without departing from the scope of the present disclosure. In addition, descriptions of well-known functions and constructions are omitted for clarity and conciseness.

Note that “one embodiment” or “an embodiment” mentioned in the present specification means that specific features, structures or characteristics relating to the embodiment are included in at least one embodiment of the present disclosure. Thus, “one embodiment” or “an embodiment” mentioned in the present specification may not be the same embodiment. Additionally, these specific features, structures or characteristics may be combined in any suitable manner in one or more embodiments.

Note that steps of the methods may be performed in the time order, however the performing sequence is not limited to the time order. Further, the described steps may be performed in parallel or independently.

An object of the embodiments of the present disclosure is to provide a method and an apparatus for generating sample data, and a non-transitory computer-readable recording medium, which can improve the label quality of sample data, and can further improve the performance of a recommendation model trained based on the sample data.

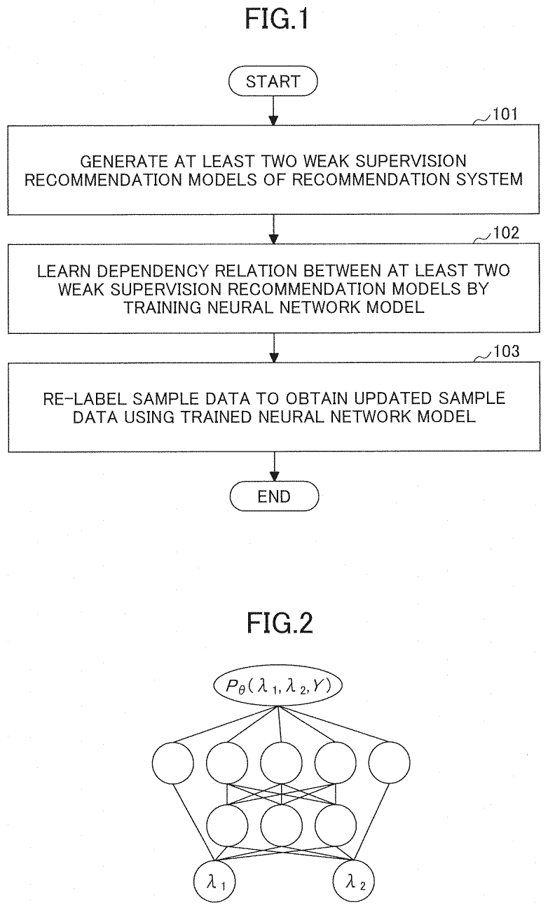

FIG. 1 is a flowchart illustrating a sample data generating method according to an embodiment of the present disclosure. As shown in FIG. 1, the sample data generating method includes the following steps.

In step 201, at least two weak supervision recommendation models of a recommendation system are generated.

Here, in the embodiment of the present disclosure, at least two weak supervision recommendation models of the recommendation system may be obtained, by performing training based on existing training samples. The training samples usually include unreliable labels, thus the recommendation models obtained by training are weak supervision recommendation models. Specifically, the training samples used by each weak supervision recommendation model may be completely identical, partially identical, or completely different, and the present disclosure is not specifically limited.

In step 102, a dependency relation between the at least two weak supervision recommendation models is learned by training a neural network model.

Here, in the embodiment of the present disclosure, in order to facilitate the learning of the dependency relation between the weak supervision recommendation models, the neural network model is constructed. Specifically, the neural network model that represents the dependency relation between the at least two weak supervision recommendation models is constructed, based on outputs of the at least two weak supervision recommendation models. The neural network model usually includes at least two layers of networks. Then, at least one parameter of the neural network model is trained by maximizing a joint probability of the outputs of the at least two weak supervision recommendation models, thereby generating the dependency relation between the at least two weak supervision recommendation models. When training the neural network model, the outputs (labels) of the at least two weak supervision recommendation models on the same sample data is used, and the training is performed so that a likelihood function of the outputs is maximized. Finally, the parameter of the neural network model, which reflects the dependency relation between the at least two weak supervision recommendation models, can be obtained.

FIG. 2 is a schematic diagram illustrating the neural network model constructed for the two weak supervision recommendation models according to the embodiment of the present disclosure. The neural network model includes two layers of network, and the two layers of neural network may represent logical operations including AND, OR, NOT, XOR and the like. Here, λ₁ and λ₂ represent the outputs of the two weak supervision recommendation models for the same sample data, respectively, Y represents a value range of labels, P_{θ}(λ₁,λ₂,Y) represents the likelihood function of the outputs of the two weak supervision recommendation models, and θ represents the parameter in the neural network model such as weight parameters between neurons or the like. The parameters of the neural network model can be trained, by maximizing the likelihood function P_{θ}(λ₁,λ₂,Y).

In step 103, the sample data is re-labelled using the trained neural network model to obtain updated sample data.

In the embodiment of the present disclosure, after the trained neural network model is obtained in step 102, labelling results of the sample data labelled by the at least two weak supervision recommendation models may be obtained. Then, a maximum likelihood estimate of the labelling results is obtained using the trained neural network model, and the sample data is re-labelled based on the maximum likelihood estimate of the labelling results. Here, the sample data to be re-labelled may be the sample data of the weak supervision recommendation models obtained by training in step 101, or may be other sample data of the recommendation system, and the embodiment of the present disclosure is not specifically limited.

For example, in the case of the neural network shown in FIG. 2, suppose that labelling results of the same sample data labelled by the two weak supervision recommendation models are λ1′ and λ2′, respectively, a maximum likelihood estimate P_{θ}(λ₁′,λ₂′,y₁) of the labelling results is obtained using the neural network model, and then the sample data may be re-labelled based on y₁, that is, the sample data may be labelled as y₁.

In the embodiment of the present disclosure, the dependency relation between the at least two weak supervision recommendation models is learned by the neural network model, and the sample data is re-labelled using the dependency relation.

Thus, the label quality of sample data can be improved, an adverse effect on the recommendation model training due to labelling errors of the sample data can be avoided or reduced, and the performance of the recommendation model obtained by training can be improved.

In order to improve the quality of the re-labeled labels, in the embodiment of the present disclosure, in step 101, a certain number of weak supervision recommendation models with certain differences between each other may be generated. That is, in order to achieve better re-labelling performance, diverse weak supervision recommendation models may be used in step 101. Specifically, in the embodiment of the present disclosure, a plurality of different types of weak supervision recommendation models may be generated by performing training based on existing weak supervision labels. Then, one or more weak supervision recommendation models whose labeling performance is higher than a predetermined threshold may be selected from each type of the weak supervision recommendation models, thereby obtaining the at least two weak supervision recommendation models.

More specifically, as an example of the method for generating the plurality of the different types of the weak supervision recommendation models by training, the types of the weak supervision recommendation models may be manually defined. In this case, in step 101, a plurality of weak supervision recommendation models with different predetermined types may be generated by performing training based on the existing weak supervision labels. For example, weak supervision recommendation models may be obtained in different ways, and the way for obtaining the weak supervision recommendation models usually includes:

(1) Pattern matching or manual labelling based on a user behavior rule;

(2) Unsupervised methods, such as abnormal behavior analysis; and

(3) Supervised or semi-supervised recommendation models based on existing labels.

As another example of the method for generating the plurality of the different types of the weak supervision recommendation models by training, a plurality of weak supervision recommendation models may be generated by performing training based on the existing weak supervision labels. Then, clustering may be performed on the recommendation results of the plurality of the weak supervision recommendation models, using a K-means clustering algorithm to obtain a plurality of clusters, thereby obtaining the plurality of the different types of the weak supervision recommendation models.

In addition, in the embodiment of the present disclosure, in order to reduce the time required for subsequent training of the neural network model, the number of the at least two weak supervision recommendation models in step 101 may be controlled. Specifically, one or more weak supervision recommendation models whose labeling performance is higher than a predetermined threshold may be selected from each type of the weak supervision recommendation models, and the weak supervision recommendation models whose labeling performance is relatively poor may be discarded. Specifically, the labeling performance may use the accuracy of labelling by the weak supervision recommendation model on unreliable sample data (that is, the label of the sample data is unreliable) as a reference index, and the weak supervision recommendation models whose accuracy is lower than a predetermined threshold may be discarded.

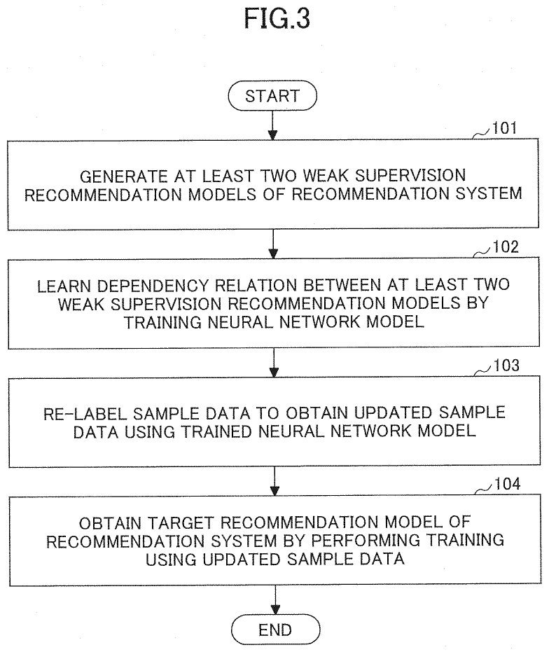

In step 103, updated sample data can be obtained. As shown in FIG. 3, the sample data generating method according to another embodiment of the present disclosure may further include the following steps after step 103.

In step 104, a target recommendation model of the recommendation system is obtained, by performing training using the updated sample data.

Here, the updated sample data is used to train the recommendation models. Since the updated sample data has labels of greater accuracy, the recommendation models obtained by training have better performance. Specifically, the structure of the target recommendation model in step 104 may be the same as any one of the at least two weak supervision recommendation models described in step 101, or may be different from the at least two weak supervision recommendation models described in step 101, and the embodiment of the present disclosure is not specifically limited.

In the sample data generating method according to the embodiment of the present disclosure, the dependency relation between the at least two weak supervision recommendation models is learned by the neural network model, and the sample data is re-labelled using the dependency relation. Thus, the label quality of sample data can be improved, an adverse effect on the recommendation model training due to labelling errors of the sample data can be avoided or reduced, and the performance of the recommendation model obtained by training can be improved.

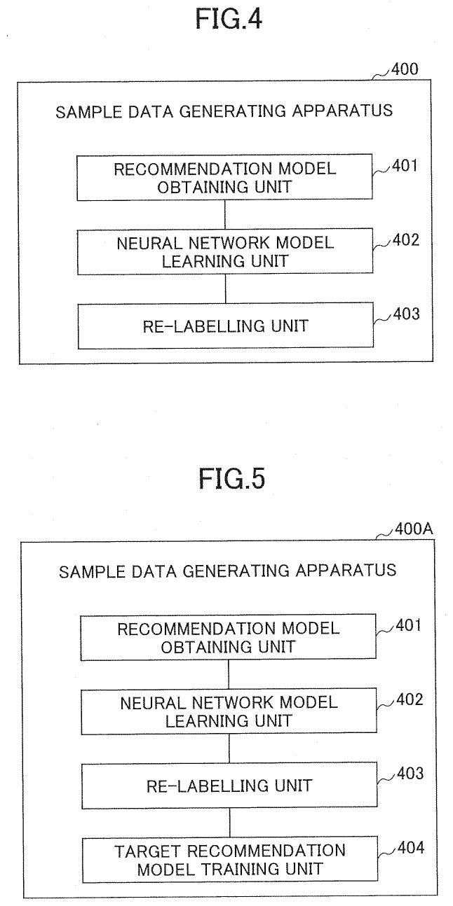

Another embodiment of the present disclosure further provides a sample data generating apparatus. FIG. 4 is a schematic diagram illustrating the sample data generating apparatus 400 according to the embodiment of the present disclosure. As shown in FIG. 4, the sample data generating apparatus 400 includes a recommendation model obtaining unit 401, a neural network model learning unit 402, and a re-labelling unit 403.

The recommendation model obtaining unit 401 generates at least two weak supervision recommendation models of a recommendation system.

The neural network model learning unit 402 learns dependency relation between the at least two weak supervision recommendation models by training a neural network model.

The re-labelling unit 403 re-labels the sample data using the trained neural network model to obtain updated sample data.

In the sample data generating apparatus 400 according to the embodiment of the present disclosure, the dependency relation between the at least two week supervision recommendation models is learned by the neural network model, and the sample data is re-labelled using the dependency relation. Thus, the label quality of sample data can be improved, an adverse effect on the recommendation model training due to labelling errors of the sample data can be avoided or reduced, and the performance of the recommendation model obtained by training can be improved.

Preferably, the neural network model learning unit 402 constructs the neural network model that represents the dependency relation between the at least two weak supervision recommendation models, based on outputs of the at least two weak supervision recommendation models. Then, the neural network model learning unit 402 trains at least one parameter of the neural network model by maximizing a joint probability of the outputs of the at least two weak supervision recommendation models to generate the dependency relation between the at least two weak supervision recommendation models.

Preferably, the re-labelling unit 403 obtains labelling results of the sample data labelled by the at least two weak supervision recommendation models. Then, the re-labelling unit 403 obtains a maximum likelihood estimate of the labelling results using the trained neural network model, and re-labels the sample data based on the maximum likelihood estimate of the labelling results.

Preferably, the recommendation model obtaining unit 401 generates a plurality of different types of weak supervision recommendation models, by performing training based on existing weak supervision labels. Then, the recommendation model obtaining unit 401 selects one or more weak supervision recommendation models whose labeling performance is higher than a predetermined threshold from each type of the weak supervision recommendation models, thereby obtaining the at least two weak supervision recommendation models.

Another embodiment of the present disclosure further provides a sample data generating apparatus. FIG. 5 is a schematic diagram illustrating the sample data generating apparatus 400A according to the embodiment of the present disclosure. As shown in FIG. 5, the sample data generating apparatus 400 includes a recommendation model obtaining unit 401, a neural network model learning unit 402, a re-labelling unit 403, and a target recommendation model training unit 404.

The target recommendation model training unit 404 obtains a target recommendation model of the recommendation system, by performing training using the updated sample data.

In the sample data generating apparatus 400A according to the embodiment of the present disclosure, by using the target recommendation model training unit 404, a recommendation model with better performance can be obtained by training.

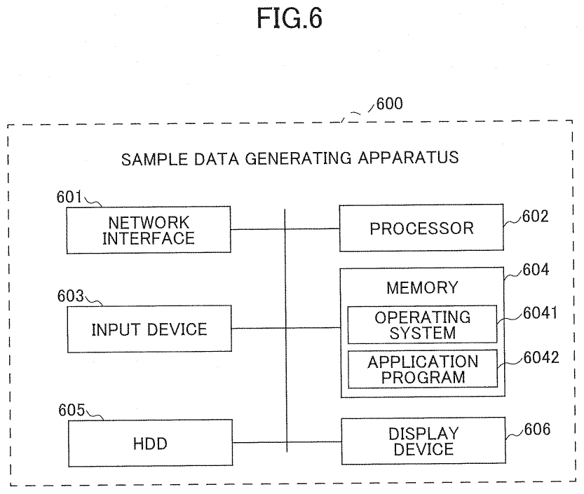

Another embodiment of the present disclosure further provides a sample data generating apparatus. FIG. 6 is a block diagram illustrating the configuration of the sample data generating apparatus 600 according to another embodiment of the present disclosure. As shown in FIG. 6, the sample data generating apparatus 600 includes a processor 602, and a memory 604 storing computer-executable instructions.

When the computer-executable instructions are executed by the processor 602, the processor 602 may generate at least two weak supervision recommendation models of a recommendation system; learn a dependency relation between the at least two weak supervision recommendation models by training a neural network model; and re-label, using the trained neural network model, the sample data to obtain updated sample data.

Furthermore, as illustrated in FIG. 6, the sample data generating apparatus 600 further includes a network interface 601, an input device 603, a hard disk drive (HDD) 605, and a display device 606.

Each of the interfaces and each of the devices may be connected to each other via a bus architecture. The processor 602, such as one or more central processing units (CPUs), and the memory 604, such as one or more memory units, may be connected via various circuits. Other circuits such as an external device, a regulator, and a power management circuit may also be connected via the bus architecture. Note that these devices are communicably connected via the bus architecture. The bus architecture includes a power supply bus, a control bus and a status signal bus besides a data bus. The detailed description of the bus architecture is omitted here.

The network interface 601 may be connected to a network (such as the Internet, a LAN or the like), collect sample data from the network, and store the collected sample data in the hard disk drive 605.

The input device 603 may receive various commands input by a user, and transmit the commands to the processor 602 to be executed. The input device 603 may include a keyboard, a click apparatus (such as a mouse or a track ball), a touch board, a touch panel or the like.

The display device 606 may display a result obtained by executing the commands, for example, a result or a progress of re-labelling the sample data.

The memory 604 stores programs and data required for running an operating system, and data such as intermediate results in calculation processes of the processor 602.

Note that the memory 604 of the embodiments of the present disclosure may be a volatile memory or a nonvolatile memory, or may include both a volatile memory and a nonvolatile memory. The nonvolatile memory may be a read-only memory (ROM), a programmable read-only memory (PROM), an erasable programmable read-only memory (EPROM), an electrically erasable programmable read-only memory (EEPROM) or a flash memory. The volatile memory may be a random access memory (RAM), which may be used as an external high-speed buffer. The memory 604 of the apparatus or the method is not limited to the described types of memory, and may include any other suitable memory.

In some embodiments, the memory 604 stores executable modules or a data structure, their subsets, or their superset, i.e., an operating system (OS) 6041 and an application program 6042.

The operating system 6041 includes various system programs for realizing various essential tasks and processing tasks based on hardware, such as a frame layer, a core library layer, a drive layer and the like. The application program 6042 includes various application programs for realizing various application tasks, such as a browser and the like. A program for realizing the method according to the embodiments of the present disclosure may be included in the application program 6042.

The method according to the above embodiments of the present disclosure may be applied to the processor 602 or may be realized by the processor 602. The processor 602 may be an integrated circuit chip capable of processing signals. Each step of the above method may be realized by instructions in a form of an integrated logic circuit of hardware in the processor 602 or a form of software. The processor 602 may be a general-purpose processor, a digital signal processor (DSP), an application specific integrated circuit (ASIC), field programmable gate array signals (FPGA) or other programmable logic device (PLD), a discrete gate or transistor logic, or discrete hardware components capable of realizing or executing the methods, the steps and the logic blocks of the embodiments of the present disclosure. The general-purpose processor may be a micro-processor, or alternatively, the processor may be any common processor. The steps of the method according to the embodiments of the present disclosure may be realized by a hardware decoding processor, or combination of hardware modules and software modules in a decoding processor. The software modules may be located in a conventional storage medium such as a random access memory (RAM), a flash memory, a read-only memory (ROM), an erasable programmable read-only memory (EPROM), an electrically erasable programmable read-only memory (EEPROM), a register or the like. The storage medium is located in the memory 604, and the processor 602 reads information in the memory 604 and realizes the steps of the above methods in combination with hardware.

Note that the embodiments described herein may be realized by hardware, software, firmware, intermediate code, microcode or any combination thereof. For hardware implementation, the processor may be realized in one or more application specific integrated circuits (ASIC), digital signal processing devices (DSPD), programmable logic devices (PLD), field programmable gate array signals (FPGA), general-purpose processors, controllers, micro-controllers, micro-processors, or other electronic components or their combinations for realizing functions of the present disclosure.

For software implementation, the embodiments of the present disclosure may be realized by executing functional modules (such as processes, functions or the like). Software codes may be stored in a memory and executed by a processor. The memory may be implemented inside or outside the processor.

Preferably, when the computer-readable instructions are executed by the processor 602, the processor 602 may construct, based on outputs of the at least two weak supervision recommendation models, the neural network model that represents the dependency relation between the at least two weak supervision recommendation models; and train at least one parameter of the neural network model by maximizing a joint probability of the outputs of the at least two weak supervision recommendation models to generate the dependency relation between the at least two weak supervision recommendation models.

Preferably, when the computer-readable instructions are executed by the processor 602, the processor 602 may obtain labelling results of the sample data labelled by the at least two weak supervision recommendation models; and obtain a maximum likelihood estimate of the labelling results using the trained neural network model, and re-label the sample data based on the maximum likelihood estimate of the labelling results.

Preferably, when the computer-readable instructions are executed by the processor 602, the processor 602 may generate, by performing training based on existing weak supervision labels, a plurality of different types of weak supervision recommendation models; and select, from each type of the weak supervision recommendation models, one or more weak supervision recommendation models whose labeling performance is higher than a predetermined threshold to obtain the at least two weak supervision recommendation models.

Preferably, when the computer-readable instructions are executed by the processor 602, the processor 602 may obtain, by performing training using the updated sample data, a target recommendation model of the recommendation system, after obtaining the updated sample data.

Another embodiment of the present disclosure further provides a non-transitory computer-readable recording medium having computer-executable instructions for execution by one or more processors. The execution of the computer-executable instructions causes the one or more processors to carry out a method for generating sample data. The method includes generating at least two weak supervision recommendation models of a recommendation system; learning a dependency relation between the at least two weak supervision recommendation models by training a neural network model; and re-labelling, using the trained neural network model, the sample data to obtain updated sample data.

As known by a person skilled in the art, the elements and algorithm steps of the embodiments disclosed herein may be implemented by electronic hardware or a combination of computer software and electronic hardware. Whether these functions are performed in hardware or software depends on the specific application and design constraints of the solution. A person skilled in the art may use different methods for implementing the described functions for each particular application, but such implementation should not be considered to be beyond the scope of the present disclosure.

As clearly understood by a person skilled in the art, for the convenience and brevity of the description, the specific working process of the system, the device and the unit described above may refer to the corresponding process in the above method embodiment, and detailed descriptions are omitted here.

In the embodiments of the present application, it should be understood that the disclosed apparatus and method may be implemented in other manners. For example, the device embodiments described above are merely illustrative. For example, the division of the unit is only a logical function division. In actual implementation, there may be another division manner, for example, units or components may be combined or be integrated into another system, or some features may be ignored or not executed. In addition, the coupling or direct coupling or communication connection described above may be an indirect coupling or communication connection through some interface, device or unit, and may be electrical, mechanical or the like.

The units described as separate components may be or may not be physically separated, and the components displayed as units may be or may not be physical units, that is to say, may be located in one place, or may be distributed to network units. Some or all of the units may be selected according to actual needs to achieve the objectives of the embodiments of the present disclosure.

In addition, each functional unit of the embodiments of the present disclosure may be integrated into one processing unit, or each unit may exist physically separately, or two or more units may be integrated into one unit.

The functions may be stored in a computer readable storage medium if the functions are implemented in the form of a software functional unit and sold or used as an independent product. Based on such understanding, the technical solution of the present disclosure, which is essential or contributes to the conventional technology, or a part of the technical solution, may be embodied in the form of a software product, which is stored in a storage medium, including instructions that are used to cause a computer device (which may be a personal computer, a server, or a network device, etc.) to perform all or a part of the steps of the methods described in the embodiments of the present disclosure. The above storage medium includes various media that can store program codes, such as a USB flash drive, a mobile hard disk, a ROM, a RAM, a magnetic disk, or an optical disk.

The present disclosure is not limited to the specifically described embodiments, and various modifications, combinations and replacements may be made without departing from the scope of the present disclosure.

What is claimed is:

1. A method for generating sample data, the method comprising:
generating at least two weak supervision recommendation models of a recommendation system;
learning a dependency relation between the at least two weak supervision recommendation models by training a neural network model; and
re-labelling, using the trained neural network model, the sample data to obtain updated sample data.

2. The method for generating sample data as claimed in claim 1,
wherein learning the dependency relation between the at least two weak supervision recommendation models by training the neural network model includes
constructing, based on outputs of the at least two weak supervision recommendation models, the neural network model that represents the dependency relation between the at least two weak supervision recommendation models; and
training at least one parameter of the neural network model by maximizing a joint probability of the outputs of the at least two weak supervision recommendation models to generate the dependency relation between the at least two weak supervision recommendation models.

3. The method for generating sample data as claimed in claim 1,
wherein re-labelling the sample data using the trained neural network model includes
obtaining labelling results of the sample data labelled by the at least two weak supervision recommendation models; and
obtaining a maximum likelihood estimate of the labelling results using the trained neural network model, and re-labelling the sample data based on the maximum likelihood estimate of the labelling results.

4. The method for generating sample data as claimed in claim 1,
wherein generating the at least two weak supervision recommendation models of the recommendation system includes
generating, by performing training based on existing weak supervision labels, a plurality of different types of weak supervision recommendation models; and
selecting, from each type of the weak supervision recommendation models, one or more weak supervision recommendation models whose labeling performance is higher than a predetermined threshold to obtain the at least two weak supervision recommendation models.

5. The method for generating sample data as claimed in claim 1, the method further comprising:
obtaining, by performing training using the updated sample data, a target recommendation model of the recommendation system, after obtaining the updated sample data.

6. An apparatus for generating sample data, the apparatus comprising:
a memory storing computer-executable instructions; and
one or more processors configured to execute the computer-executable instructions such that the one or more processors are configured to
generate at least two weak supervision recommendation models of a recommendation system;
learn a dependency relation between the at least two weak supervision recommendation models by training a neural network model; and
re-label, using the trained neural network model, the sample data to obtain updated sample data.

7. The apparatus for generating sample data as claimed in claim 6,
wherein the one or more processors are configured to
construct, based on outputs of the at least two weak supervision recommendation models, the neural network model that represents the dependency relation between the at least two weak supervision recommendation models; and
train at least one parameter of the neural network model by maximizing a joint probability of the outputs of the at least two weak supervision recommendation models to generate the dependency relation between the at least two weak supervision recommendation models.

8. The apparatus for generating sample data as claimed in claim 6,
wherein the one or more processors are configured to
obtain labelling results of the sample data labelled by the at least two weak supervision recommendation models; and
obtain a maximum likelihood estimate of the labelling results using the trained neural network model, and re-label the sample data based on the maximum likelihood estimate of the labelling results.

9. The apparatus for generating sample data as claimed in claim 6,
wherein the one or more processors are configured to
generate, by performing training based on existing weak supervision labels, a plurality of different types of weak supervision recommendation models; and
select, from each type of the weak supervision recommendation models, one or more weak supervision recommendation models whose labeling performance is higher than a predetermined threshold to obtain the at least two weak supervision recommendation models.

10. The apparatus for generating sample data as claimed in claim 6,
wherein the one or more processors are further configured to
obtain, by performing training using the updated sample data, a target recommendation model of the recommendation system, after obtaining the updated sample data.

11. A non-transitory computer-readable recording medium having computer-executable instructions for execution by one or more processors, wherein, the computer-executable instructions, when executed, cause the one or more processors to carry out a method for generating sample data, the method comprising:
generating at least two weak supervision recommendation models of a recommendation system;
learning a dependency relation between the at least two weak supervision recommendation models by training a neural network model; and
re-labelling, using the trained neural network model, the sample data to obtain updated sample data.
